(19) United States
(12) Patent Application Publication
(10) Pub. No.: US 2004/0071983 A1
(43) Pub. Date: Apr. 15, 2004

(54) Heated mirror, particularly for vehicles, and method for manufacturing it

(75) Inventors: Giovanni Manfre', Caldiero (IT); Andrea Mirandola, Este (IT)

Correspondence Address: Dr. MODIANO & ASSOCIATI S.p.A., Via Meravigli, 16, Milano, 20123, IT

(73) Assignee: ISOCLIMA S.p.A.

(21) Appl. No.: 10/622,636

(22) Filed: Jul. 21, 2003

Related U.S. Application Data
(63) Continuation-in-part of application No. 09/721,901, filed on Nov. 27, 2000, now abandoned.
Application No. 09/721,901 is a continuation of application No. PCT/EP99/03627, filed on May 26, 1999.

(30) Foreign Application Priority Data
May 28, 1998 (IT) PD98A000134

(51) Int. Cl. B32B 15/00

(52) U.S. Cl. 428/432; 428/457

(57) ABSTRACT

A heated mirror, comprising a glass body (1) on one face whereof a film of an electrically conductive metal (2) is deposited so as to form a actual reflective surface. Two conductive busbars (3) are associated with the film (2) made of electrically conductive metal and are suitable to allow the flow of an electric current in the film (2).

### CROSS-REFERENCE TO RELATED APPLICATIONS

This application is a continuation-in-part of U.S. patent application Ser. No. 09/721,901, filed on Nov. 27, 2000, which in turn was a continuation of PCT/ EP99/03627 filed on May 26, 1999.

### BACKGROUND OF THE INVENTION

The present invention relates to a heated mirror.

Its most widespread but not exclusive applications are in the automotive field and in the field of transportation in general as rear-view mirrors.

Rear-view mirrors manufactured with conventional technologies in fact are affected, especially during the winter period, by the inconvenience of misting or, worse still, frosting and icing on their external surface.

In such conditions it is absolutely impossible for the driver to drive away with his vehicle; the driver is accordingly forced, in many cases, to resort to the use of mechanical means, such as scrapers, to defrost the mirror until he clears all (or at least most) of the reflective surface.

Actually, conventional heated mirrors are currently widely used which are obtained starting from a glass plate having a suitable geometric shape, even a curved one (with a cylindrical, spherical or aspheric configuration) to which a reflective layer (usually made of silver, chromium, aluminum or oxide-metal films) is applied at the rear or front part; a resistive element is fixed to said layer by means of an adhesive film.

The resistive element substantially consists of a coil formed by an electric conductor which is applied to the rear of the reflective surface and has, at its ends, terminals for connection to an electric power source.

Accordingly, it is sufficient to connect said terminals of the resistive element to the power supply to achieve the flow of a current whereby heat is generated due to the Joule effect.

However, such heat generation is not perfectly uniform and therefore the mirror is heated by means of a transmission of the heat by conduction from the resistive element that generated it, through the reflective surface and the glass layer, to the external surface to be demisted or defrosted or deiced.

Accordingly, it is necessary to supply adequate electric power to the resistive element for a certain time in order to produce the gradual heating of the entire volume of the glass.

It should be observed that the reflective surface does not have per se particular conductive characteristics and is unable to independently generate the heat required to demist the mirror; said heat must instead be supplied by the resistive element.

The reflective layer, regardless of its position (at the front or at the rear), can actually be a hindrance to the flow of heat: it is in fact an interface which has different physical characteristics with respect to glass, and it is necessary to take this additional layer into account as regards heat transmission.

For an equal level of supplied electric power and of dispersed heat flow, the heating time is therefore obviously longer with respect to a system which has no additional layers between the heating system and the surface to be heated.

Moreover, the heat generated by the resistive coil can, over time, degrade the characteristics of the adhesive of the film, no longer ensuring good thermal contact between the glass and the conductive film; accordingly, the efficiency of the entire heating system can be compromised and degraded over time.

EP-A-0 677 434 discloses a mirror with a heater comprising a glass base plate on the back of which is formed a reflective heating resistor titanium film deposited by sputtering or vacuum vapor deposition, and a pair or opposing electrodes provided on the film.

### SUMMARY OF THE INVENTION

The aim of the present invention is to provide a mirror which allows to perform defrosting and/or demisting in a time which is not longer than achieved with conventional mirrors.

Within the scope of this aim, an object of the present invention is to provide a heated mirror which is capable of ensuring excellent viewing of the reflected image and, in case of strong lighting, for example in the presence of headlights, better visibility than conventional mirrors.

Another object of the present invention is to provide a heated mirror which ensures good heating uniformity on the entire surface thereof.

A further object of the invention is to provide a heated mirror which can be manufactured in a shorter time than conventional models and by means of simpler and quicker assembly steps.

A further object of the invention is to provide a heated mirror which can be manufactured at very low costs.

A further object of the invention is to provide a heated mirror which allows to vary the coloring of the reflective surface thereof.

A further object of the present invention is to provide a heated mirror which ensures a longer life time than conventional mirrors.

A further object of the invention is to provide a heated mirror in which deterioration of the reflective surface caused by the action of weather is prevented.

A further object of the present invention is to provide a heated mirror which ensures good electric and optical characteristics over time.

A further object of the invention is to provide a heated mirror which can operate even with very low temperatures (down to −50° C.)

A still further object is to provide a heated mirror which has a lighter structure than conventional models and at the same time has a higher mechanical strength, thus reducing the risk of breakage due to impact.

This aim, these objects and others which will become apparent hereinafter are achieved by a heated mirror, according to the present invention, comprising a glass body on one face whereof a film of an electrically conductive metal is deposited by Vacuum Arc Deposition so as to form an actual reflective surface, two conductive busbars being associated with said metal film and being suitable to allow the flow of an electric current in said film.

### BRIEF DESCRIPTION OF THE DRAWINGS

Further characteristics and advantages of the present invention will become apparent from the description of a preferred embodiment, illustrated in the enclosed drawings wherein:

FIG. 1 is a sectional view of a first embodiment of the mirror according to the invention, with the heating coating applied on the glass body of the mirror, at the side whereon the rays of light are directly incident;

FIG. 2 is a sectional view of a second embodiment of the mirror according to the invention, with the heating coating applied on the glass body of the mirror, at a side which is opposite to the one whereon the rays of light are incident;

FIG. 3 is a cross-sectional view of the mirror according to the invention, with the conductive elements arranged according to a first embodiment; and

FIG. 4 is a cross-sectional view of the mirror according to the invention, with the conductive elements arranged according to a second embodiment.

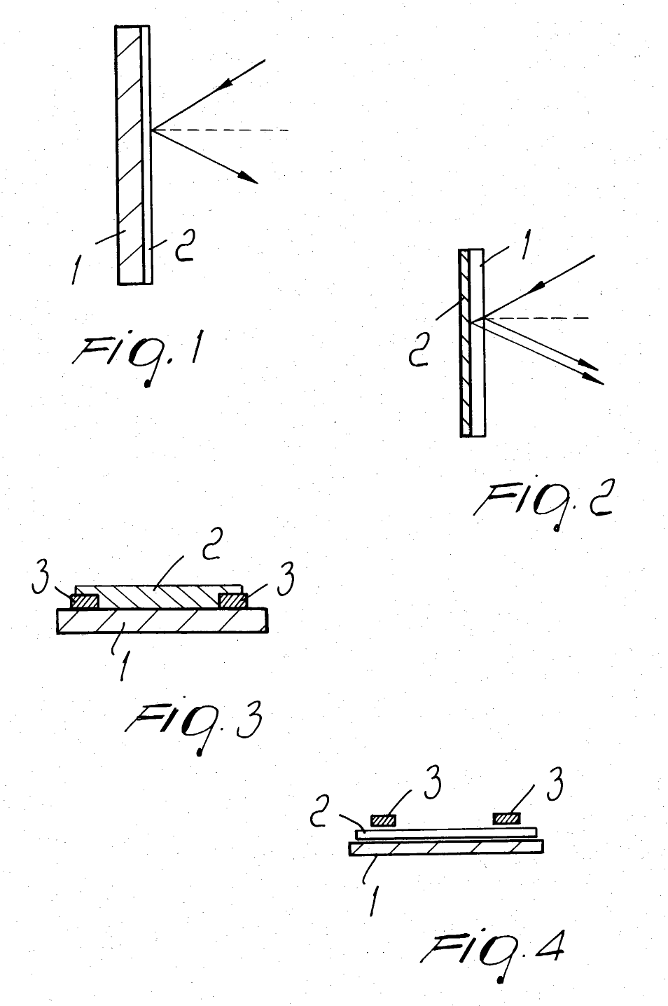

### DESCRIPTION OF THE PREFERRED EMBODIMENTS

A heated mirror according to the present invention comprises a glass body 1 which in this case has a planar structure and which, in this constructive solution, has a reduced thickness of approximately 1-2 mm.

The planar glass body 1 can be conveniently curved with currently used methods in order to obtain a mirror which has a cylindrical, spherical or aspheric shape.

At the rear face of the glass body 1 two conductive busbars 3 are provided, of a per se known type, obtained by means of a per se known screen-printing process, using silver paste in this case.

The screen-printed silver paste that constitutes the pair of busbars 3 is preferably dried by means of a thermal treatment in order to improve the adhesion thereof to the glass body 1.

In other equivalent constructive solutions, different materials can be employed to obtain the two busbars 3, provided that they have adequate characteristics.

In particular, it is possible to use materials which do not require a thermal treatment for drying.

A coating surface 2 is delimited, by masking the complementary surface, according to per se known treatment methods, on the same rear face of the glass body 1 on which the conductive busbars 3 have been screen-printed.

Thereafter, the glass body 1 is placed inside a deposition chamber, of a per se known type, in order to deposit onto the rear face thereof a thin titanium film 2 which thus constitutes the actual reflective surface of the mirror.

Preferably, the thin titanium film 2 is deposited according to a technique commonly known as Vacuum Arc Deposition.

As an alternative, it is possible to use other different deposition techniques for the titanium film, for example those known as DC Magnetron Sputtering, CVD, etc. . . .

In this embodiment, the thin titanium film is a single layer.

In other embodiments it is possible to deposit other equivalent conducting materials (silver, aluminum, etc . . .) instead of titanium.

Sputtering is a known technique used for thin film deposition. A substrate to be coated, for example, and a target material to be deposited are held closed together in a plasma chamber. The substrate is cooled. Heavy ions from the plasma bombard the target and knock out small particles of target material. These “condense” on the cooled substrate.

Vacuum Vapor Deposition (VVD) is known to be a deposition technique conducted in a vacuum or low-pressure plasma environment with an atomic or molecular, condensable vapor source to deposit films and coatings onto substrates. The vapor source may consist of a solid or liquid surface evaporated by heating in the vacuum or low-pressure plasma environment for the process called Physical Vapor Deposition (PVD), or of a chemical precursor for the process called Chemical Vapor Deposition (CVD).

Vacuum Arc Deposition (VAD) is also a known deposition technique (see, for example, Handbook of Vacuum Arc Science and Technology by R. L. Boxman, P. J. Martin and D. M. Sanders-Noyes Publications, Park Ridge, N.J. , 1995) based on an electrical discharge, known as vacuum arc, between a pair of electrodes located in a vacuum chamber. The electrical current is carried by a plasma produced by ionizing material which arc evaporates from the electrodes. The plasma is formed as an energetic jet with ions having a high kinetic energy which can be directed with magnetic fields. A coating will form on the surface which intercepts the plasma jet which is dense and nanograined.

High deposition rates were found to be achievable with excellent coating uniformity.

Compared with the sputtering or VVD, the VAD technique, as used in the present invention to produce Ti coatings on a glass body, was found to be highly advantageous.

Indeed, no process gas is used in VAD, the mono- (single) layer coating being deposited under high vacuum conditions with no contamination and with lower average roughness and much higher deposition rates than in sputtering or VVD.

The large vacuum chambers needed to keep away the coating substrate from the heating source, the problems in controlling the trajectories of the deposition particles and the poor film thickness uniformity over large areas of a mirror surface common for the VVD technique were found to be avoidable with the VAD technique.

A titanium mirror deposition film is considered satisfactory if it has both a rather high reflective coefficient (R>40%) and an electrical resitivity such as to allow, with a supplied battery voltage of 12-13 V and a detected current lower than 3.5 A , a heating sufficient to melt, at ambient temperatures of about −15° C. an ice layer formed on the mirror in less than 150 seconds.

It is however very difficult to attain these parameters, since the studies carried out have shown that, in order to achieve the required reflectivity, a titanium coating film should have a thickness of minimum 100 nm. Such a thickness nevertheless leads to reaching rather high currents, of more than 4 A, that are considered beyond the safety limit.

It was found that low thickness titanium coating layers with high reflectivity are difficult, if not impossible to obtain industrially and at convenient costs by sputtering techniques, where several deposition steps appear necessary in order to attain the necessary reflectivity-film thickness parameters. This also means that a multi-layer film is provided.

In contrast, with the above mentioned high density, high deposition rate and fine crystalline structure provided by the VAD technique, it was practically and most advantageously obtained, at very competitive costs, a TI deposition mono-layer with a reflective coefficient R>42% and with a controlled thickness being generally as low as 37-40 nm and not higher than 48 nm. Such low thickness allowed, during application of heating voltages of 12-13 V and rapid deicing, detected currents of 3.5 A or lower. Higher thickness, between 50 nm and 90 nm were found, in the condition of the VAD deposition, to still provide reflective coefficients higher than 40% with detected or sensed currents lower than, and anyway not exceeding 3A.

The VAD technique is also efficiently usable for the deposition of the other conducting materials (silver, aluminum, etcetera) of the embodiments mentioned above.

Such technique was also found to allow controlled doping of the titanium coating directly in the plasma phase with suitable materials, such as silver and chrome, that enhanced the coating reflectivity (R>42%) and optimised its electrical resistivity (a coefficient of resistivity α<1.5 ×10⁻³ was obtained) within a suitable thickness range of the monolayer coating of 37 -40 nm.

The two conductive busbars are meant to constitute electrodes of the heated mirror; for this purpose, they are welded to conducting terminals (preferably made of copper or silver) in order to allow connection to an electric power source, which can be, very simply, the battery of a motor vehicle.

Studies and experiments have shown that, in order to have an efficient. operation and avoid local heating at the busbar/coating interface that may cause busbar separation form the coating, the ratio between the surface resistivity of the busbar and that of the coating should tend to 1.

Values of such ratio of at least 0.8-0.9 and higher have been successfully obtained for the mirror busbars according to the invention, by using the screen-printing process for application of the conductive paste, as mentioned above, with thickness not higher than 10 microns. A substantially constant temperature, not exceeding 80° C., has been achieved all over the mirror coating surface. The coated mirrors and busbars obtained with the mentioned process were subjected to repeated heating cycles with temperature increasing from −15° C. to about 80° C. in about 150 seconds, corresponding to a duty period of at least five years, without variations of the operation/constructional parameters or failures being observed.

It is then necessary to spray a paint or, as an alternative, apply a suitable material on the coated rear face of the glass body 1, in order to form a protective layer so as to ensure its stability over time and thus prevent any oxidation and degradation of the final metallic layer.

The protective layer can be composed of multiple layers of different materials in other embodiments.

It can also be rendered externally adhesive in order to allow a good bonding with a plastic support of the type commonly used in conventional mirrors.

In particular, the protective layer must also conveniently insulate the welding regions between the terminals and the conductive busbars in order to prevent the generation of electrical discharges if water is present.

The glass body 1 is then placed in a controlled environment (i.e., in an environment wherein the relative humidity, the temperature and all the other environmental conditions are kept within preset limits) so that the protective layer of paint dries.

The heated mirror thus obtained is characterized in that the pure titanium film constitutes the reflective surface and simultaneously acts as a resistive element, since after the appropriate connection of the two conductive busbars 3 to the electric power source it allows the direct flow of an electric current and accordingly generates heat by means of the Joule effect.

The heat can then be transmitted directly toward the front face of the mirror, since there is no interposed material that slows its transmission.

Moreover, the heat is practically unaffected by any dispersion from the rear face of the mirror 2 toward the outside environment thanks to the presence of the layer of protective paint, which also acts as a heat insulator.

Directly after the deposition of the titanium film, it is possible to superimpose thereon other titanium-based films, particularly titanium nitride and titanium oxide films, by means of successive depositions, simply by introducing nitrogen and oxygen in the deposition chamber.

By appropriately combining the films a heated mirror is obtained whose reflective surface has a different color and/or a different surface resistivity.

In particular, it is possible to provide the reflective surface on the front face of the mirror so that it has water-repellent properties.

It is also possible to select the coloring of the reflective surface of the above-described mirror according to the present invention, by appropriately combining the thicknesses of the titanium-based compound films in order to achieve, for example, the coloring that corresponds to the coloring of the body of the vehicle on which the mirror is to be installed.

In a different embodiment, the two conductive busbars 3 can be provided, as an alternative to deposition on glass, directly on said film made of an electrically conductive metallic material, so as to simplify all the operations for assembly to the conductive terminals for connection to the electric power source (see FIG. 4).

In this case, the conductive busbars 3 can be constituted by thin metal strips (made for example of copper, aluminum, silver, et cetera) which are applied to the metal film 2.

Contact can be provided by pressure or, in other cases, by fixing the conductive busbars to an adhesive film to be applied to the layer of electrically conductive metal.

The adhesive film, which must of course be able to withstand the operating temperatures reached during the heating step, also has a useful safety function, since in case of accidental breakage of the mirror it prevents fragments from detaching.

The conductive busbars 3 thus provided can be welded or fixed to suitable connectors in order to provide connection to the electric power supply system.

In practice it has been observed that the present invention effectively achieves all of the intended aim and objects.

It should be observed that the above-described mirror allows a considerable constructive simplification with respect to conventional models, since it is not necessary to insert any element in addition to the reflective surface; in particular, there is no adhesive resistive film.

The above-described heated mirror according to the present invention allows, in an equal time, to defrost a much larger surface than conventional mirrors.

If the temperature reached by the mirror during operation is higher than the temperature that is sufficient for defrosting, it is possible to provide the mirror with a temperature sensor, or with a PCT as an alternative, so that the device, by acting on the conductive terminals, limits the electric power supply so that the temperature remains substantially constant at the intended value.

In particular, an important advantage of the present invention is that a heated mirror has been provided which is capable of ensuring optimum viewing of the reflected image and better visibility with respect to conventional types in case of strong lighting, such as for example in the presence of headlights.

A further important advantage of the present invention is that a heated mirror has been provided which ensures good heating uniformity on the entire surface, since the titanium film itself constitutes not only the actual reflective surface but also the resistive element that generates heat by means of the Joule effect.

A further advantage is that a heated mirror has been provided which can be manufactured in a shorter time than conventional models.

A further advantage is certainly that it is possible to produce a heated mirror in practice at very low costs.

A further advantage of the present invention is that a heated mirror has ben provided whose coloring is determined by the physical characteristics of the reflective surface.

Moreover, it should be observed that the present invention also achieves the advantage of providing a heated mirror which ensures a longer life time than conventional mirrors.

A further advantage is that a heated mirror has been provided which is protected against degradation of the reflective surface caused by the action of weather.

A further advantage of the present invention is that a heated mirror has been provided which ensures good electric and optical characteristics over time.

A further advantage is that the above-described heated mirror can operate even with very low temperatures (down to −50° C.) simply by varying the physical characteristics of the titanium film and without having to insert other resistive elements.

A further advantage is that a heated mirror has been provided which has a lighter structure than conventional models and at the same time has a greater mechanical strength, so as to reduce the risk of impact breakage.

The weight reduction and increase in mechanical strength can be achieved by means of a chemical tempering process.

It should also be observed that the above-described mirror can be subjected to additional treatments, such as marking or painting, all of which are per se known, so as to accordingly provide equivalent configurations.

It is also possible to apply to the above-described heated mirror according to the present invention a colored screen-printed paste on the front face in order to conceal the presence of the conductive busbars.

The present invention is susceptible of numerous modifications and variations, all of which are within the scope of the same inventive concept.

In one constructive configuration, for example, it is possible to coat the front face of the mirror with a titanium oxide coating having water-repellent characteristics.

Another alternative is achieved by providing a mirror according to the invention in which the reflective layer on the front face is obtained by deposition of the film made of an electrically conductive metal.

Moreover, the conductive reflective layer can be coated with a coating of titanium oxide with water-repellent characteristics, so that as a whole said layer is a single element with reflective, heating, water-repellent and color characteristics at the same time.

During the production process, some treatments may be swapped without altering the final characteristics of the resulting surfaces.

The materials employed, so long as they are compatible with the contingent use, as well as the dimensions and the shape, may be any according to requirements.

The disclosures in Italian Patent Application No. PD98A000134 from which this application claims priority are incorporated herein by reference.

What is claimed is:

1. A heated mirror, comprising a glass body on one face whereof a reflective film of an electrically conductive metal is deposited by Vacuum Arc Deposition so as to form an actual reflective surface, two conductive busbars being associated with said reflective metal film and being suitable to allow the flow of an electric current in said reflective metal film.

2. The mirror according to claim 1, wherein said glass body is a flat plate.

3. The heated mirror of claim 1, wherein said glass body is curved so that cylindrical, spherical or aspheric mirror shapes are providable.

4. The mirror according to claim 1, wherein said two conductive busbars are interposed between said reflective metal film and said glass body.

5. The mirror according to claim 1, wherein said two conductive busbars are formed directly on said reflective metal film.

6. The mirror according to claim 1, wherein said two conductive busbars are provided by screen printing.

7. The mirror according to claim 6, wherein said screen-printed conductive busbars are provided by means of silver paste.

8. The mirror according to claim 1, wherein said conductive busbars are metal strips arranged on said reflective metal film.

9. The mirror according to claim 8, wherein said metal strips are fixed to said reflective metal film by pressure.

10. The mirror according to claim 1, wherein said reflective metal film is titanium-based.

11. The mirror according to claim 1, wherein said reflective metal film is made of pure titanium.

12. The heated mirror of claim 1, wherein the ratio between surface resistivity of the reflective film and surface resistivity of the busbars is comprised between 0.8 and 0.9, preferably tending to 1.

13. The mirror according to claim 1, wherein said glass body is chemically tempered.

14. A heated mirror, comprising a glass body on one face whereof a reflective film of an electrically conductive metal is deposited by Vacuum Arc Deposition so as to form an actual reflective surface with a reflective coefficient of at least 40% and preferably of at least 42%, two conductive busbars being associated with said reflective metal film and being suitable to allow the flow of an electric current in said reflective metal film.

15. The heated mirror of claim 14, wherein the reflective film has a thickness not higher than 48 nm, and generally as low as 37-40 nm.

16. The heated mirror of claim 14, wherein the reflective film has a thickness between 50 and 90 nm.

17. The heated mirror of claim 15, wherein the reflective film has a resitivity coefficient α<1.5 ×10 ⁻³.

18. The heated mirror of claim 17, wherein the reflective film supplied with a voltage of 12-13 V provides a detectable current of 3.5 A or lower.

19. The heated mirror of claim 14, wherein said glass body is curved so that cylindrical, spherical or aspheric mirror shapes are providable.

20. The heated mirror of claim 14, wherein the ratio between surface resistivity of the reflective film and surface resistivity of the busbars is comprised between 0.8 and 0.9, preferably tending to 1.

21. The heated mirror of claim 14, wherein the reflective film is made of pure titanium.

22. The heated mirror of claim 14, wherein the reflective film is made by Vacuum Arc Deposition of titanium doped in the plasma phase.

23. A heated mirror, comprising a glass body on one face whereof a reflective film of an electrically conductive metal is deposited by Vacuum Arc Deposition so as to form an actual reflective surface with a reflective coefficient of at least 40%, and preferably of at least 42%, and a thickness not higher than 48 nm, two conductive busbars being associated with said reflective metal film and being suitable to allow the flow of an electric current in said reflective metal film.

24. The heated mirror of claim 22, wherein the reflective film has a thickness which is generally as low as 40 nm.

25. The heated mirror of claim 23, wherein the reflective film has a resitivity coefficient α<1.5 ×10 ⁻³.
